(19) United States
(12) Patent Application Publication
(10) Pub. No.: US 2023/0016107 A1
(43) Pub. Date: Jan. 19, 2023

(54) INSULATED ELECTRICAL CABLE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (KR)

(72) Inventors: Satoshi MURAO, Mie (JP); Katsuki HASHIGUCHI, Mie (JP)

(21) Appl. No.: 17/780,693

(22) PCT Filed: Nov. 16, 2020
(86) PCT No.: PCT/JP2020/042575

§ 371 Date: May 27, 2022

(30) Foreign Application Priority Data
Nov. 28, 2019 (JP) 2019-215055

(51) Int. Cl. C09D 123/12; H01B 3/44; H01B 7/295

(52) U.S. Cl. CPC C09D 123/12; H01B 3/44; H01B 7/295

(57) ABSTRACT

Provided is an insulated electrical cable that includes a base resin containing a polypropylene resin, and a metallic hydroxide serving as a flame retardant, and has high wear resistance and favorable low-temperature resistance. An insulated electrical cable 10 includes a wire conductor 12, and an insulating coating 14 that coats an outer circumference of the wire conductor 12, and the insulating coating 14 includes a polymer component containing a polypropylene resin, and a flame retardant containing a metallic hydroxide. The polypropylene resin has a heat of fusion of at least 35 J/g, and in a molecular weight distribution of the polymer component, a number average molecular weight calculated at a peak with the largest area is at least 5.00×10⁴.

### TECHNICAL FIELD

The present disclosure relates to an insulated electrical cable.

### BACKGROUND

As insulated electrical cables that are used in vehicles such as automobiles, or various types of devices, halogen-free electrical cables with an insulating coating made of a resin composition containing no halogen are sometimes used, aiming at environmental sustainability and the like. One representative example of an insulating coating constituting a halogen-free electrical cable is an insulating coating in which a polypropylene resin is used as a base resin, and a metallic hydroxide such as magnesium hydroxide is added as a flame retardant. An insulated electrical cable with an insulating coating containing a base resin including a polypropylene resin, and metallic hydroxide is disclosed in, for example, Patent Documents 1 and 2 below. Although adding particles of metallic hydroxide to the base resin may affect the characteristics of the base resin, in the documents below, the characteristics of the insulating coating such as wear resistance and cold resistance are improved by reforming the metallic hydroxide using surface treatment or the like, or adjusting the composition of the base resin, for example.

### PRIOR ART DOCUMENT

### Patent Document

Patent Document 1: JP 2002-212354 A

Patent Document 2: JP 2010-174113 A

### SUMMARY OF THE INVENTION

### Problems to be Solved

In insulated electrical cables with an insulating coating made of a material in which a polypropylene resin is used as a base resin and a metallic hydroxide is added thereto as a flame retardant, the low-temperature resistance of the insulating coating tends to decrease. As one method for increasing the low-temperature resistance, polypropylene may be used that has a large amount of amorphous components (that is to say, a low crystallinity) and a large average molecular weight. However, in this case, due to the low crystallinity, the wear resistance of the insulating coating tends to decrease.

To avoid a decrease in wear resistance caused when a polypropylene resin having a large amount of amorphous components and a large average molecular weight is used, a method is also conceivable in which a highly crystalline polypropylene resin is added as a part of a resin component. With this, an increase in the amount of crystal can improve the wear resistance of the insulating coating, but it is difficult to maintain sufficient low-temperature resistance.

As described above, in an insulated electrical cable with an insulating coating in which a polypropylene resin is used as a base resin and a metallic hydroxide is added thereto, it is difficult to sufficiently improve both the wear resistance and the low-temperature resistance of the insulating coating. Sufficient consideration of the physical property of a polypropylene resin to be used as a base resin is essential to improve wear resistance and low-temperature resistance. Therefore, it is an object to provide an insulated electrical cable that contains a base resin including a polypropylene resin, and a metallic hydroxide serving as a flame retardant, and has high wear resistance and low-temperature resistance.

### Means to Solve the Problem

An insulated electrical cable of the present disclosure includes: a wire conductor; and an insulating coating that coats an outer circumference of the wire conductor, wherein the insulating coating includes a polymer component containing a polypropylene resin, and a flame retardant containing a metallic hydroxide, the polypropylene resin has a heat of fusion of at least 35 J/g, and in a molecular weight distribution of the polymer component, a number average molecular weight calculated at a peak with the largest area is at least 5.00×10⁴.

### Effect of the Invention

An insulated electrical cable according to the present disclosure includes a base resin containing a polypropylene resin, and a metallic hydroxide serving as a flame retardant, and has high wear resistance and low-temperature resistance.

### BRIEF DESCRIPTION OF THE DRAWINGS

FIG. 1 is a perspective view illustrating an insulated electrical cable according to an embodiment of the present disclosure.

FIG. 2 is a DSC curve measured for a sample Al.

### DETAILED DESCRIPTION TO EXECUTE THE INVENTION

[Description of Embodiments of Present Disclosure]

First, embodiments of the present disclosure will be listed and described.

An insulated electrical cable of the present disclosure includes: a wire conductor; and an insulating coating that coats an outer circumference of the wire conductor, wherein the insulating coating includes a polymer component containing a polypropylene resin, and a flame retardant containing a metallic hydroxide, the polypropylene resin has a heat of fusion of at least 35 J/g, and in a molecular weight distribution of the polymer component, a number average molecular weight calculated at a peak with the largest area is at least 5.00×10⁴.

In the insulating coating constituting the insulated electrical cable, the polypropylene resin has a heat of fusion of at least 35 J/g, and a sufficient amount of crystalline polypropylene can be ensured. A large amount of crystalline polypropylene contributes to an improvement in the wear resistance of the insulating coating. Also, since in the molecular weight distribution of the polymer component, the number average molecular weight calculated at a peak with the largest area is at least 5.00×10⁴, the insulating coating has favorable low-temperature resistance. In this way, by appropriately setting a heat of fusion and a molecular weight distribution of the polymer component containing the polypropylene resin, it is possible to enhance both the wear resistance and the low-temperature resistance of the insulating coating.

Here, preferably, in the molecular weight distribution of the polymer component, a polydispersity degree Mw/Mn, which is defined as a ratio of weight average molecular weight Mw to number average molecular weight Mn, is at least 5.90, the polydispersity degree Mw/Mn being calculated at the peak with the largest area. Thus, a wide molecular weight distribution increases the processability of the insulating coating, and the outer appearance of the insulating coating formed by extrusion or the like is improved. Improvement in outer appearance means that the surface of the insulating coating is less uneven, leading also to improvements in wear resistance and low-temperature resistance.

Preferably, the polypropylene resin contains homo polypropylene and block polypropylene. As a result of homo polypropylene and block polypropylene being mixed together, a desired heat of fusion and a desired molecular weight distribution are likely to be achieved by adjusting the mixing ratio or the like. Also, homo polypropylene is highly effective to improve the crystallinity of the polymer component. On the other hand, block polypropylene is highly effective to improve the processability of the insulating coating. By mixing homo polypropylene and block polypropylene together, it is possible to efficiently realize improvements in wear resistance and low-temperature resistance.

Preferably, the polymer component further contains thermoplastic elastomer. With this, metallic hydroxide particles are likely to be dispersed into the polymer component, resulting in a realization of particularly high effects of improving the wear resistance and the low-temperature resistance of the insulating coating.

Preferably, the metallic hydroxide is magnesium hydroxide. Magnesium hydroxide is available at a low price, and gives high flame resistance to the insulating coating.

Preferably, an arithmetic average roughness Ra of a surface of the insulating coating is smaller than or equal to 3.00 μm. With this, the insulating coating has a pleasing outer appearance, and accordingly, high wear resistance and favorable low-temperature resistance are likely to be realized.

[Detail of Embodiments of Present Disclosure]

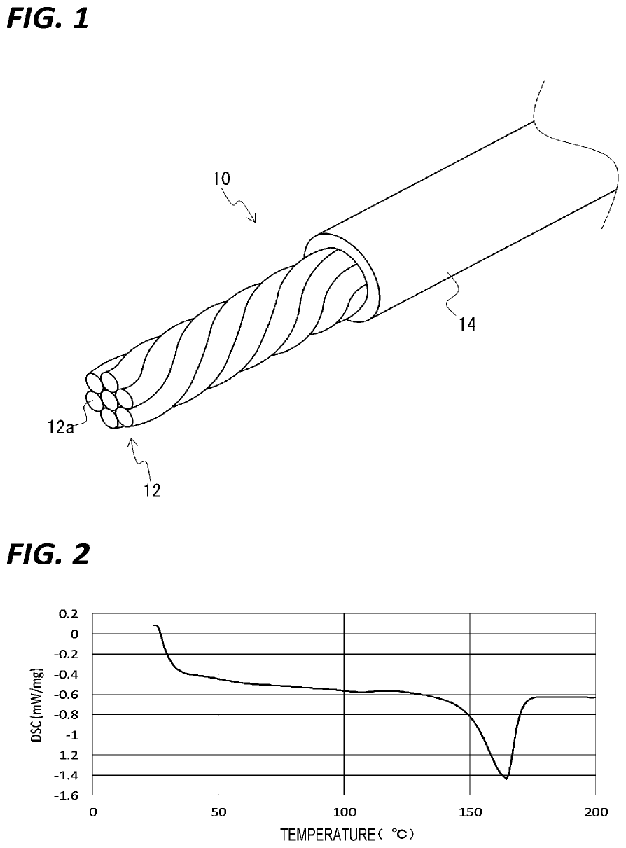

Hereinafter, an insulated electrical cable according to an embodiment of the present disclosure will be described in detail with reference to the drawings. In the present specification, unless otherwise noted, various types of physical properties of materials are indicated as values measured in ambient temperature and the atmosphere.

[1] Configuration of Insulated Electrical cable FIG. 1 shows an overview of an insulated electrical cable 10 according to an embodiment of the present disclosure. As shown in FIG. 1, the insulated electrical cable 10 includes a wire conductor 12, and an insulating coating 14 that coats an outer circumference of the wire conductor 12 and is made of a resin composition. The insulated electrical cable 10 can be obtained by placing a resin composition to serve as the insulating coating 14 on the outer circumference of the wire conductor 12 using extrusion or the like.

The material constituting the wire conductor 12 is not particularly limited, and copper is typically used. But, instead of copper, a metal material such as aluminum or iron may also be used. These metal materials may be alloys. Examples of another metal material to be used to form an alloy include iron, nickel, magnesium, silicon, and combination of these metals. The wire conductor 12 may be configured by a single wire, or a twisted wire obtained by twisting a plurality of bare wires 12a together. In view of ensuring the flexibility of the insulated electrical cable 10, the wire conductor 12 is preferably a twisted wire.

The insulating coating 14 is constituted by a resin composition that includes a base resin made of a polymer component containing a polypropylene resin, and a flame retardant containing a metallic hydroxide. Although the resin composition constituting the insulating coating 14 will be described in detail later, in the resin composition constituting the insulating coating 14, the polypropylene resin has a heat of fusion at least a predetermined lower limit, and the polymer component containing a polypropylene resin has a predetermined molecular weight distribution.

In the insulated electrical cable 10 according to the present embodiment, the sizes of the components, such as the cross-sectional area of the wire conductor 12 and the thickness of the insulating coating 14, are not particularly limited. Also, the usage of the insulated electrical cable 10 according to the present embodiment is not particularly limited, and the insulated electrical cable 10 may be used as various types of electrical cables for automobiles, electric/electronic devices, information and telecommunications, power supply, boats and ships, and aircraft. As will be described later, the insulating coating 14 has excellent flame resistance, as well as wear resistance and low-temperature resistance, and thus the insulated electrical cable 10 can be appropriately used particularly as an electrical cable for an automobile.

The insulated electrical cable 10 according to the present embodiment may be used in a mode of a single wire, or a mode of a wire harness including a plurality of insulated electrical cables. All of the insulated electrical cables constituting a wire harness may be insulated electrical cables 10 according to the present embodiment, or some of the insulated electrical cables may be insulated electrical cables 10 according to the present embodiment.

[Resin Composition Constituting Insulating Coating]

The following will describe in detail the resin composition constituting the insulating coating 14 of the insulated electrical cable 10 according to the present embodiment.

The resin composition constituting the insulating coating 14 includes a base resin, and a flame retardant containing a metallic hydroxide. The polymer component serving as the base resin contains a polypropylene resin (PP resin), where the PP resin has a heat of fusion of at least 35 J/g, and the polymer component has a number average molecular weight of at least 5.00×10⁴.

(Physical property of Resin Composition)

The heat of fusion of a resin material serves as an indicator for the crystallinity of the resin material, and the larger the heat of fusion is, the higher the crystallinity is, that is to say, the larger the amount of crystal is. In the present embodiment, the PP resin contained in the resin composition constituting the insulating coating 14 has a heat of fusion of at least 35 J/g. As a result of the PP resin having a heat of fusion of at least 35 J/g, the insulating coating 14 can ensure a sufficient amount of crystalline polypropylene. When the resin composition constituting the insulating coating 14 contains a sufficient amount of crystalline polypropylene, the wear resistance of the insulating coating 14 increases. In view of further improving the wear resistance, the heat of fusion of the PP resin is preferably at least 37 J/g, and more preferably at least 39 J/g. No upper limit is particularly given to the heat of fusion, but the heat of fusion is preferably not greater than about 80 J/g for the reason of preventing that the absorption of an additive agent such as a flame retardant into the polymer component is reduced due to an excessive increase in the amount of crystal, for example.

The heat of fusion of the PP resin can be measured in conformity with JIS K 7122 by measuring, using a differential scanning calorimeter (DSC), the heat of transition when the PP resin is heated. Note that, as shown in working examples, when the polymer component contains, as the PP resin, homo polypropylene and block polypropylene, melting peaks derived from these two types of polypropylene are typically not separated from each other, and only one melting peak appears that is derived from the crystal structures of two types of polypropylene (see FIG. 2). The heat of fusion may be measured only for the PP resin, or may be measured for the entire polymer component also containing another resin. Alternatively, the heat of fusion may be measured for the entire resin composition further containing a component other than the polymer component, such as the flame retardant.

In the present embodiment, the polymer component constituting the insulating coating 14 has a number average molecular weight of at least 5.00×10⁴. If a plurality of peaks appear in a molecular weight distribution, a number average molecular weight calculated at the peak with the largest area, out of these peaks, is defined as the number average molecular weight of the polymer component. That is to say, in a molecular weight distribution, the number average molecular weight calculated at the peak with the largest area has a value of at least 5.00×10⁴.

When the number average molecular weight of the polymer component constituting the insulating coating 14 is at least 5.00×10⁴, the low-temperature resistance of the insulating coating 14 is favorable. That is to say, in a low temperature environment, embrittlement of the insulating coating 14 is suppressed, and stretchability of the insulating coating 14 is ensured. In view of further improving these effects, the number average molecular weight of the polymer component is preferably at least 5.50×10⁴, and more preferably at least 5.70×10⁴. No upper limit is particularly given to the number average molecular weight, but the number average molecular weight is preferably not greater than about 1.00×10⁵ in view of suppressing a reduction in flowability of the resin composition, for example.

As described above, the molecular weight distribution of the polymer component constituting the insulating coating 14 preferably have a predetermined number average molecular weight, and a polydispersity degree, which is defined as a ratio Mw/Mn of weight average molecular weight Mw to number average molecular weight Mn, is at least 5.90. If a plurality of peaks appear in the molecular weight distribution, a polydispersity degree Mw/Mn at the peak with the largest area is defined as the polydispersity degree Mw/Mn of the polymer component, similarly to the definition of the above-described molecular weight distribution. That is to say, the polydispersity degree Mw/Mn at the peak with the largest area in the molecular weight distribution is preferably at least 5.90.

A polydispersity degree Mw/Mn is a parameter indicating the magnitude of the width of a molecular weight distribution of a polymer component, and the larger the polydispersity degree Mw/Mn is, the more widely the molecular weights are distributed. If the polydispersity degree Mw/Mn is set to at least 5.90, the width of the molecular weight distribution is large, and thus the flowability of the resin composition constituting the insulating coating 14 is high. This increases the processability of the resin composition, and when an insulating coating 14 is formed by extrusion or the like, an insulating coating 14 having a pleasing outer appearance can be obtained. The pleasing outer appearance of the insulating coating 14 not only is important as itself, but also means that its surface hardly includes an uneven structure, serving as a good indicator for high resistance and cold resistance, which are characteristics adversely affected by an uneven structure. In view of further enhancing these effects, the polydispersity degree Mw/Mn is preferably at least 6.00, and further preferably at least 6.20. No upper limit is particularly given to the polydispersity degree Mw/Mn, but the polydispersity degree Mw/Mn is preferably not greater than about 8.00 in view of preventing the characteristics of the insulating coating 14 from being affected when the molecular weight distribution is too large.

The molecular weight distribution of the polymer component can be evaluated by gel permeation chromatography (GPC), for example. Note that it is sufficient that the above-described values obtained from the molecular weight distribution, that is, the number average molecular weight and the polydispersity degree Mw/Mn, satisfy the above-described predetermined ranges for the entire polymer component even when the polymer component contains a plurality of types of resins, but the above-described values preferably satisfy the above-described predetermined ranges for only a PP resin contained in the polymer component.

The unevenness of the surface of the insulating coating 14 can be quantitatively evaluated as a surface roughness. For example, a surface roughness Ra (arithmetic average roughness) is preferably not greater than 4.00 μm. With this, the high smoothness of the surface of the insulating coating 14 serves as a good indicator of a pleasing outer appearance of the insulated electrical cable 10, and high wear resistance and favorable low-temperature resistance thereof. The arithmetic average roughness Ra of the surface is further preferably not greater than 3.00 μm, or not greater than 2.50 pm. Note that, in many cases, the arithmetic average roughness Ra of the surface of the insulating coating 14 is substantially not affected by a contribution of a solid additive agent such as a flame retardant, and is represented as a result of a composition of the polymer component. The arithmetic average roughness Ra of a surface can be measured in conformity with JIS B0601, using a surface roughness meter.

As described above, in the insulated electrical cable 10 according to the present embodiment, when the PP resin contained as the polymer component in the insulating coating 14 has a heat of fusion of at least 35 J/g, and the polymer component has a number average molecular weight of at least 5.00×10⁴, the insulating coating 14 has excellent wear resistance and low-temperature resistance. Furthermore, when the polydispersity degree Mw/Mn of the polymer component is at least 5.90, or when the arithmetic average roughness Ra of the surface is not greater than 4.00 μm, the electrical cable has a pleasing outer appearance, and the wear resistance and low-temperature resistance thereof are likely to be further improved.

(Constituent Material of Resin Composition)

The specific components of the resin composition constituting the insulating coating are not particularly limited, as long as the resin composition includes a polymer component containing a PP resin, and a flame retardant containing a metallic hydroxide, and has the above-described physical properties. The following will describe preferable components.

(1) Polymer Component

The percentage of the PP resin in the polymer component is not particularly limited. However, the PP resin accounts for preferably at least 50% by mass in the entire polymer component, and more preferably at least 80% by mass.

The PP resin refers to a polymer including a propylene unit, and may be any of three types, namely, homo polypropylene (homo PP), block polypropylene (block PP), and random polypropylene (random PP). Details of the type of resin constituting the PP resin, that is, one of the above-described three types that is included in the PP resin, and specific resins used as the respective types of resin are not particularly limited, and only one type may be used or a plurality of types may be used, as long as the resin has the above-described heat of fusion, and contributes to the number average molecular weight of the polymer component.

The PP resin preferably includes homo PP and block PP, in view of the fact that it is easy to realize a desired heat of fusion or a desired molecular weight distribution, for example. Homo PP is highly crystalline, and is highly effective to improve the wear resistance of the insulating coating 14. On the other hand, block PP is effective to improve the long-term heat resistance of an electrical cable, and is effective to improve the low-temperature resistance due to its high absorption of an additive agent such as a flame retardant. Also, block PP is also effective to improve the processability of a resin composition. By mixing homo PP and block PP together, it is easy to realize both the above-described heat of fusion and molecular weight distribution, and as a result, it is easy to obtain an insulating coating 14 that is excellent in both heat resistance and low-temperature resistance.

The compounding ratio of homo PP to block PP may be selected as appropriate, so that physical properties such as a heat of fusion and a molecular weight distribution can have predetermined values. However, in view of exerting the characteristics of the two types of polypropylene in a balanced manner, the compounding ratio is preferably 1:4 to 4:1 as mass ratio of homo PP to block PP. More preferably, the compounding ratio is 1:3 to 3:1, or 1:2 to 2:1.

When block PP is used, the specific molecular structure of the block PP is not particularly limited. However, block PP is preferably used that contains, in addition to a propylene unit, an ethylene unit of less than 10% of the entire ethylene content, and includes three phases, namely, a polypropylene (PP) phase, a polyethylene (PE) phase, and an ethylene-propylene copolymer (EPR) phase. Also, the block PP preferably has a melting point of at least 160° C. This melting point is equal to the melting point of homo PP. Accordingly, when block PP and homo PP are used in mixture, one peak is to be observed in a measurement of a heat of transition when they are heated using a DSC or the like. Furthermore, in view of increasing the effect of improving low-temperature resistance of block PP when it is mixed with the homo PP, the block PP preferably has a larger number average molecular weight, and has a larger polydispersity degree Mw/Mn than those of the homo PP, and preferably increases the number average molecular weight and the polydispersity degree Mw/Mn of a polymer component when the block PP is added thereto.

Even if a PP resin includes a plurality of components as homo PP and block PP, each of the components may have any physical property as long as the PP resin as a whole obtained by combining these components together has a predetermined physical property. Note however that, in view of easily increasing the flowability or the like of a resin composition, it is preferable that the melt flow rate (MFR) of the homo PP be about 0.3 to 2.0 g/10 min, and the melt flow rate of the block PP be about 0.3 to 2.0 g/10 min

The PP resin constituting the insulating coating 14 may be or may not be subjected to modification such as acid modification. Examples of a PP resin that is not subjected to acid modification can include polypropylene, an ethylene propylene copolymer, a 1-butene propylene copolymer, a propylene.1-butene.ethylene copolymer, a propylene.1-hexene copolymer, a propylene.1-hexene.ethylene copolymer, and a propylene.4 (or 5)-methyl-1,4-hexadiene copolymer. The acid-modified PP resin may be a PP resin obtained by subjecting the above-described PP resin to acid modification, and a PP resin known as adhesive polyolefin, polyolefin-system adhesive polymer, adhesive resin, polyolefin-system adhesive resin, or the like may be used. Note that a PP resin that is not subjected to modification is preferably used, in view of the fact that the wire conductor 12 and the insulating coating 14 are prevented from adhering to each other, and processability is increased when the insulating coating 14 is removed from terminal portions or the like. Also, the PP resin constituting the insulating coating 14 is preferably not cross-linked.

The polymer component constituting the insulating coating 14 may be made only of a PP resin, or may include not only a PP resin but also another polymer. Preferably, the polymer component preferably includes not only a PP resin but also thermoplastic elastomer. The thermoplastic elastomer functions to increase the dispersibility and compatibility of the flame retardant contained in the polymer component. Examples of applicable thermoplastic elastomers include SEBS, and TPO (polyolefin-system elastomer). The thermoplastic elastomer may be acid-modified or may be unmodified. In view of achieving sufficient effects by addition, the additive amount of thermoplastic elastomer is preferably at least 5% by mass as a percentage of the entire polymer component, and more preferably at least 10% by mass. On the other hand, in view of preventing damage of the characteristics of the PP resin, the additive amount of the thermoplastic elastomer is preferably not greater than 20% by mass as a percentage of the entire polymer component. Note that the polymer component preferably include no halogen-containing polymer, in view of realizing an insulated electrical cable 10 that is a halogen-free electrical cable.

(2) Flame Retardant

In the present embodiment, the flame retardant contained in the insulating coating 14 includes metallic hydroxide. Metallic hydroxide preferably accounts for at least 50% by mass in the entire flame retardant, and more preferably accounts for at least 80% by mass. Further preferably, the flame retardant is made only of metallic hydroxide except for a minor constituent such as a surface acting agent.

Examples of metallic hydroxides constituting the flame retardant include magnesium hydroxide, and aluminum hydroxide. Of these types of metallic hydroxide, magnesium hydroxide is particularly preferable because it is available at a low price and can have high flame resistance. The metallic hydroxide is contained in the resin composition in a particle state.

The average particle size of the metallic hydroxide constituting the flame retardant is preferably at least 0.1 μm, or at least 0.5 μm, in view of preventing secondary aggregation of the particles when the metallic hydroxide is mixed with a resin component, and in view of using it at a low price. On the other hand, the average particle size of the metallic hydroxide is preferably not greater than 10 μm, or not greater than 5 μm, in view of preventing the characteristics of the polymer component including the PP resin from being damages, for example. The metallic hydroxide may be subjected to surface treatment using a silane coupling agent, higher fatty acid, or a polyolefin wax, in order to improve the dispersibility or the like. Note however that, in the present embodiment, as a result of the polymer component having a predetermined heat of fusion and a predetermined molecular weight distribution, the insulating coating 14 has excellent characteristics such as wear resistance and low-temperature resistance even if the metallic hydroxide is not subjected to surface treatment.

The content of the flame retardant contained in the resin composition constituting the insulating coating 14 is preferably at least 30 parts by mass or at least 50 parts by mass, to 100 parts by mass of polymer component, in view of exerting sufficient flame resistance. On the other hand, the content of the flame retardant is preferably not greater than 200 parts by mass, and more preferably not greater than 100 parts by mass, to 100 parts by mass of polymer component, in view of preventing the characteristics of the insulating coating 14 from being reduced due to an excessive amount of content of the flame retardant.

(3) Other Components

In the insulated electrical cable 10 according to the present embodiment, the resin composition constituting the insulating coating 14 may appropriately contain, in addition to the above-described polymer component and flame retardant, other components such as various types of additive agents. Examples of additive agents other than the flame retardant include antioxidants such as sulfuric compounds and hindered phenol compounds, antistaling agents such as zinc oxide and imidazole compounds, metal deactivators, lubricants, stabilizers, ultraviolet absorbers, pigments, and colorants.

The content of the additive agent is not particularly limited as long as it is in a range in which the characteristics of the polymer component and the flame retardant are not significantly damaged. For example, the total content of the additive agent other than the metallic hydroxide is preferably not greater than 20 parts by mass, and more preferably not greater than 10 parts by mass, to 100 parts by mass of the polymer component. Note that, preferably, the resin composition constituting the insulating coating 14 does not contain an additive agent that contains halogen, in view of realizing an insulated electrical cable 10 that is a halogen-free electrical cable.

Working Examples

Hereinafter, working examples will be described. Note that the present invention is not limited to these working examples. Here, the composition of polymer components constituting the insulating coating was changed to change the physical properties of the polymer components, and the relationship between the physical properties and the characteristics of the insulating coating was tested. In the following, samples were manufactured and various types of tests were conducted in ambient temperature and the atmosphere, unless otherwise noted.

[Test Method]

(1) Manufacturing Samples

The components shown in Table 1 were mixed and kneaded in a predetermined content ratio at 260° C., and resin compositions of samples A1 to A5 and samples B1 to B3 were prepared. In the table, the compounding amounts of the components are represented with respect to 100 parts by mass of the sum of the polymer components. Furthermore, by bringing the resin compositions into a pellet state, and molding, by extrusion, the resin compositions in the coating thickness of 0.20 mm around the circumference of a twisted wire conductor with a nominal cross-sectional area of 0.35 mm², an insulated electrical cable was obtained.

Materials used as the components of the resin composition constituting the insulating coating are as follows:
(Block PP)
EC9: “NOVATEC EC9” manufactured by Japan Polypropylene Corporation, MFR=0.5 g/10 min; shear viscosity 890 Pa s (temperature 230° C., shear velocity 100/s)
EC9GD: “NOVATEC EC9GD” manufactured by Japan Polypropylene Corporation, MFR=0.5 g/10 min; shear viscosity 1040 Pa·s (temperature 230° C., shear velocity 100/s)
(Homo PP)
FY6H: “NOVATEC FY6H” manufactured by Japan Polypropylene Corporation, MFR=1.9 g/10 min
EA9FTD: “NOVATEC EA9FTD” manufactured by Japan Polypropylene Corporation, MFR=0.4 g/10 min
(Thermoplastic Elastomer)
H1041: Hydrogenated SEBS (unmodified), “Tuftec H1041” manufactured by Asahi Kasei Corporation, MFR=5.0 g/10 min
M1913: maleic acid-modified SEBS, “Tuftec M1913” manufactured by Asahi Kasei Corporation, MFR=5.0 g/10 min
(Other Components)
Magnesium hydroxide: “Magnifin H10” manufactured by Huber Engineered
Materials
Sulfur system antioxidant: “NOCRAC MB” manufactured by Ouchi Shinko Chemical Industrial Co., Ltd.
Hindered phenol system antioxidant: “Irganox 1010” manufactured by BASF
Antistaling agent: zinc oxide, “Second Type” manufactured by Hakusui Tech Co., Ltd.
Metal deactivator: “Irganox MD 1024” manufactured by BASF

(2) Evaluation Method

(Measurement of Heat of Transition by Heating)

With respect to resin compositions constituting the insulating coating of each sample, the heat of transition by heating was measured using a differential scanning calorimeter (DSC). The melting point was read out from the obtained result, and the heat of fusion was obtained based on JIS K 7122.

(Evaluation of Molecular Weight Distribution)

With respect to resin compositions constituting the insulating coating of each sample, a molecular weight distribution was obtained by gel permeation chromatography (GPC). Then, the number average molecular weight Mn and the polydispersity degree Mw/Mn at the peak at which the largest area was obtained were evaluated.

(Measurement of Surface Roughness)

An arithmetic average roughness Ra of the surface of the insulated electrical cable of each sample was measured in conformity with JIS B0601, using a surface roughness meter. The measurement was made at three positions, and the average thereof was recorded.

(Measurement of Wire Manufacturability)

When, in the manufacturing an insulated electrical cable of a sample, both pellet manufacturing and extrusion was possible, “A” was given as an evaluation meaning that wire manufacturability is high. On the other hand, when at least one of pellet manufacturing and extrusion was not possible, “B” was given as an evaluation meaning that wire manufacturability is low.

(Wear Resistance Test)

A wear resistance of the insulating coating of the insulated electrical cable of each sample was evaluated in conformity with ISO6722 by a scrape wear test (blade reciprocating test). In the test, the load to be applied to the blade was set to 7.00 ±0.05 N. Then, the number of times the blade reciprocates until the conductor is exposed was measured. The test was conducted on three insulated electrical cables of each sample, and the average value of the number of times of reciprocating was recorded. Also, when the number of times of reciprocating was at least 450 times, “A” was given as an evaluation meaning that wear resistance is high, and when the number of times of reciprocating was less than 450, “B” was given as an evaluation meaning that wear resistance is low.

(Evaluation of Low-Temperature Resistance)

To evaluate low-temperature resistance, the wire conductor was removed from the insulated electrical cable of each sample, and only the insulating coating was obtained, and elongation at a low temperature was measured. Elongation was measured by a tensile test in the environment of 0° C. and with the test speed of 50 mm/min, in conformity with JIS K 7161. When the elongation was greater than 200%, “A” was given as an evaluation meaning that low-temperature resistance is high, and when the elongation was less than 200%, “B” was given as an evaluation meaning that low-temperature resistance is low.

[Test Results]

FIG. 2 shows a DSC curve obtained by the measurement of heats of transition by heating the representative sample Al. The horizontal axis represents temperature. The vertical axis represents DSC value (flow of heat), and values in the negative direction indicate endotherm.

According to FIG. 2, an endotherm peak was observed at 165° C. Because the melting point of homo PP is about 165° C., this peak resulted from melting of crystalline polypropylene. This peak is tailed on a low temperature side, but is a single peak. That is to say, a PP resin constituting the resin composition contains both homo PP and block PP, but the homo PP and the block PP do not have independent peaks, and it is conceivable that the polypropylene structures contained in the two types of PP form crystals that are melted at similar temperatures. With respect to the samples A2 to A5, and the samples B1 and B2, one melting peak was observed as a range of about 160° C. to 165° C.

Also, in Table 1, component compositions (unit: parts by mass) of the resin compositions constituting the insulating coating of each sample are shown. Also, the results of the evaluation are summarized that include results of the above-described measurement of heats of transition by heating. For wear resistance and low-temperature resistance, corresponding measured values are given and an evaluation classification thereof is given in square brackets [ ]. Note that, for the sample B3, pellet manufacturing was impossible and no insulated electrical cable to serve as a test sample could be manufactured, and thus evaluations could not be conducted.

TABLE 1

| Sample number | | | A1 | A2 | A3 | A4 | A5 | B1 | B2 | B3 |
|---|---|---|---|---|---|---|---|---|---|---|
| Component | Block PP | EC9 | — | — | — | — | — | 90 | — | — |
| composition | | EC9GD | 48.75 | 69.4 | 48.75 | 28.1 | 48.75 | — | 90 | — |
| | Homo PP | FY6H | 41.25 | 20.6 | 41.25 | 61.9 | — | — | — | 90 |
| | | EA9FTD | — | — | — | — | 41.25 | — | — | — |
| | Thermoplastic | H1041 | 10 | — | — | — | — | — | — | — |
| | elastomer | M1913 | — | 10 | 10 | 10 | 10 | 10 | 10 | 10 |
| | Magnesium hydroxide | | 70 | 70 | 70 | 70 | 70 | 70 | 70 | 70 |
| | Sulfur system antioxidant | | 3 | 3 | 3 | 3 | 3 | 3 | 3 | 3 |
| | Metal oxide | | 3 | 3 | 3 | 3 | 3 | 3 | 3 | 3 |
| | Hindered phenol system | | 3 | 3 | 3 | 3 | 3 | 3 | 3 | 3 |
| | antioxidant | | | | | | | | | |
| | Metal deactivator | | 0.5 | 0.5 | 0.5 | 0.5 | 0.5 | 0.5 | 0.5 | 0.5 |
| Evaluation | Measurement | Melting point | 165 | 163 | 165 | 165 | 162 | 163 | 161 | — |
| result | of heat of | (° C.) | | | | | | | | |
| | transition by | Heat of fusion | 39 | 37 | 39 | 41 | 37 | 36 | 33 | — |
| | heating | (J/g) | | | | | | | | |
| | Molecular | Number average | 5.76 × 10⁴ | 5.98 × 10⁴ | 5.78 × 10⁴ | 5.53 × 10⁴ | 7.06 × 10⁴ | 4.51 × 10⁴ | 6.30 × 10⁴ | — |
| | weight | molecular | | | | | | | | |
| | distribution | weight Mn | | | | | | | | |
| | | Polydispersity | 6.02 | 6.27 | 6.05 | 5.92 | 5.81 | 8.39 | 6.45 | — |
| | | degree Mw/Mn | | | | | | | | |

| | | | | | | | | |
|---|---|---|---|---|---|---|---|---|
| Surface roughness Ra (μm) | 2.31 | 2.98 | 2.36 | 2.34 | 3.93 | 2.10 | 5.61 | — |
| Wire manufacturability | A | A | A | A | A | A | A | B (pellet |
| | | | | | | | | manufacturing |
| | | | | | | | | impossible) |
| Wear resistance (average number | 530[A] | 455[A] | 501[A] | 585[A] | 455[A] | 1232[A] | 160[B] | — |
| of times of reciprocating/times) | | | | | | | | |
| Low-temperature resistance | 390[A] | 450[A] | 410[A] | 385[A] | 300[A] | 170[B] | 540[A] | — |
| (elongation at 0° C./%) | | | | | | | | |

According to Table 1, in the samples A1 to A5, the PP resin has a heat of fusion of at least 35 J/g, and the polymer component has a number average molecular weight of at least 5.00×10⁴. Accordingly, the insulating coating has high wear resistance and favorable low-temperature resistance.

When comparing the samples A1 to A5 with each other, the greater the heat of fusion of the PP resin is, the higher the wear resistance is (the larger the average number of times of reciprocating is). Also, generally, the larger the number average molecular weight Mn of the polymer component is, the more favorable the low-temperature resistance is (the larger the elongation at a low temperature is). Based on these results, there is a clear correlation between the heat of fusion of the PP resin and the wear resistance. Also, there is a clear correlation between the number average molecular weight Mn of the polymer component and the low-temperature resistance. It is conceivable that the reason why the PP resin has a high heat of fusion is that an increase in crystallinity contributes to an improvement of the wear resistance.

Furthermore, generally, there is a tendency that the larger the polydispersity degree Mw/Mn is, the smaller the arithmetic average roughness Ra of the surface is. Specifically, in the sample A5 whose polydispersity degree Mw/Mn is less than 5.90, the surface roughness Ra is not greater than 4.00 μm but widely exceeds 3.00 μm, whereas in the samples A1 to A4 whose polydispersity degrees Mw/Mn are at least 5.90, the surface roughnesses Ra are less than 3.00 μm. It is conceivable that the processability of the resin composition by extrusion is improved the larger the width of the molecular weight distribution of the corresponding polymer component indicated by the polydispersity degree Mw/Mn is, and the surface roughness of the obtained insulating coating is reduced. Also, in the sample A5 whose surface roughness is large, the characteristic of low-temperature resistance is significantly lower than those of the samples A1 to A4, and the wear resistance is also in a relatively low region. The sample A5 has the same composition as that of the sample A3 except for the type of the homo PP used. The main reason why the obtained insulating coatings have different outer appearances, wear resistances, and low-temperature resistances may be that, due to selection of a specific type of homo PP, the molecular weight distributions represented by the polydispersity degree Mw/Mn of the polymer component are different.

The samples A2 to A4 have the same components, and different content ratio of block PP to homo PP. As the ratio of the homo PP increases from the sample A2 to the sample A4, the wear resistance is improved. On the other hand, as the ratio of the block PP increases from the sample A4 to the sample A2, the low-temperature resistance is improved. From these results, it can be said that the homo PP largely contributes, due to its high crystallinity, to an improvement in the wear resistance of the insulating coating. On the other hand, it can be said that the block PP largely contributes to an improvement in the low-temperature resistance of the insulated electrical cable.

The sample A1 and the sample A3 are different from each other in the type of added thermoplastic elastomer, more specifically, depending on whether or not they are acid modified. However, the evaluation results of these wear resistance and low-temperature resistance have no large difference. With this, it can be said that the type of thermoplastic elastomer is not largely affect the characteristics of the insulating coating.

Lastly, the samples B1 to B3 are reviewed. In the sample B 1, the number average molecular weight Mn of the polymer component is less than 5.00×10⁴. Accordingly, in the evaluation of low-temperature resistance, elongation of at least 200% was not obtained, and sufficient low-temperature resistance was not obtained. On the other hand, in the sample B2, the heat of fusion of the PP resin is less than 35 J/g. Accordingly, in the evaluation of wear resistance, the average number of times of reciprocating did not reach 450 times, and sufficient wear resistance was not obtained. Both the sample B1 and the sample B2 contain only block PP as a PP resin, and have different types of block PP, but in both samples, it was not possible to realize sufficient wear resistance and low-temperature resistance. The sample B3 contains only homo PP as a PP resin, but has significantly low flowability, and thus it was not possible to process it into an insulating coating by extrusion. It may be impossible to achieve, only by selecting a single PP resin, an insulating coating that realizes both high wear resistance and low-temperature resistance, unless a PP resin that has sufficiently large heat of fusion and number average molecular weight Mn is selected.

The embodiments of the present disclosure have been described in detail, but the present invention is not limited to the above-described embodiment. Various modifications are possible without departing from the spirit of the present invention.

### LIST OF REFERENCE NUMERALS

10 Insulated electrical cable

12 Wire conductor

12a Bare wire

14 Insulating coating

1. An insulated electrical cable comprising:
a wire conductor; and an insulating coating that coats an outer circumference of the wire conductor,
wherein the insulating coating includes a polymer component containing a polypropylene resin, and a flame retardant containing a metallic hydroxide,
the polypropylene resin has a heat of fusion of at least 35 J/g, and
in a molecular weight distribution of the polymer component, a number average molecular weight calculated at a peak with the largest area is at least 5.00×10⁴, and
the polypropylene resin contains at least one of homo polypropylene and block polypropylene.

2. The insulated electrical cable according to claim 1,
wherein in the molecular weight distribution of the polymer component, a polydispersity degree Mw/Mn, which is defined as a ratio of weight average molecular weight Mw to number average molecular weight Mn, is at least 5.90, the polydispersity degree Mw/Mn being calculated at the peak with the largest area.

3. The insulated electrical cable according to claim 1,
wherein the polypropylene resin contains homo polypropylene and block polypropylene.

4. The insulated electrical cable according to claim 3,
wherein the polypropylene resin accounts for at least 50% by mass in the entire polymer component.

5. The insulated electrical cable according to claim 3,
wherein neither the homo polypropylene nor the block polypropylene are acid-modified.

6. The insulated electrical cable according to claim 1,
wherein the polymer component further contains thermoplastic elastomer.

7. The insulated electrical cable according to claim 1,
wherein the metallic hydroxide is magnesium hydroxide.

8. The insulated electrical cable according to claim 1,
wherein an arithmetic average roughness Ra of a surface of the insulating coating is smaller than or equal to 3.00 μm.
